(19) United States
(12) Patent Application Publication
(10) Pub. No.: US 2020/0156225 A1
(43) Pub. Date: May 21, 2020

(54) TRIM BALANCE WEIGHT INSTALLATION TOOL AND METHOD FOR INSTALLING A TRIM BALANCE WEIGHT IN A ROTOR

(71) Applicant: MTU Aero Engines AG, Muenchen (DE)

(72) Inventors: Stephen MATTIA, East Haddam, CT (US); John WILBER, East Hampton, CT (US)

(21) Appl. No.: 16/195,721

(22) Filed: Nov. 19, 2018

(51) Int. Cl. B25B 27/14; F01D 5/16; F01D 25/28

(52) U.S. Cl. CPC B25B 27/14; F01D 5/16; F01D 25/28; F05D 2260/96; F05D 2230/60; F05D 2240/30; F05D 2220/323

(57) ABSTRACT

An installation tool for an airfoil trim balance weight includes a tool body having a support for supporting the tool body with respect to the trim balance weight. A linear actuator is provided for contacting a tab of the trim balance weight, the linear actuator for moving linearly with respect to the tool body in a linear motion toward the support to permit the tab to bend. A method for installation, a gas turbine engine and a method for manufacturing also are provided.

The present invention relates generally to gas turbine engines, such as aircraft engines, and more particularly to methods and devices for installing trim weights on airfoils of gas turbine engines.

### BACKGROUND OF THE INVENTION

FIG. 1 shows an aircraft gas turbine engine 100 with a rotor of a low pressure turbine having a plurality of airfoils 104 and radially outer interlocking platforms 102. To balance such rotors it is known to place trim balance weights such as trim balance weight 200 at the end of the airfoil.

FIGS. 2 and 3 show such a trim balance weight 200 attached to the airfoil 104 and platform 102 by being placed between a throat opening between two airfoils 104. Trim balance weight 200 can be made of metal and has a pre-formed tab 202 extending over the leading edge of airfoil 104 and a pre-formed tab 206 extending over an edge of the platform 102. Prior to a final installation step, a further tab 204 extends outwardly from the trailing edge of airfoil 104 approximately perpendicular to a camber line. Tab 204 then is bent around a trailing edge the airfoil 104 by a tool to secure trim balance weight 200.

### SUMMARY OF THE INVENTION

Baseline installation tools for the trim balance weights have used claw mechanisms. A hook is placed around the leading edge and a handle mechanism rotates a claw that bends the tab 204. These tools have struggled to secure the trim balance, which can result in liberated balance weights during operation. These tools also risk pinching or damaging the airfoil in the process, for example due to the hook required to interact with the leading edge. Moreover, the tools have generally been made of metal, so if parts of the tool break off or the tool is left whole in the engine, foreign object damage can occur.

The present invention provides an installation tool for an airfoil trim balance weight comprising:

a tool body having a support for supporting the tool body with respect to the trim balance weight; and

a linear actuator for contacting a tab of the trim balance weight, the linear actuator for moving linearly with respect to the tool body in a linear motion toward the support to permit the tab to bend.

The linear motion of the present invention can provide for better bending, and avoid the difficulty of installation using a rotating claw mechanism. The support for such previous claw mechanisms also required a hook to support the rotational movement, and such a hook can damage the leading edge for example.

The support thus preferably has a support surface extending perpendicularly with respect to the linear motion, and forming a general L shape with a tool body surface interacting with an airfoil surface, for example a suction surface of the airfoil. Most preferably the angle between the support surface and the tool body surface is more 90 degrees, for example between 90 and 120 degrees, so that placement of the support surface over the leading edge or a tab of the trim balance weight is simplified. No hook is required.

The installation tool may have a handle connected to the tool body, and fixed thereto, for example via friction from a slot and slot insert interaction.

The tool body preferably has a body linear groove or body groove insert extending longitudinally in the direction of the linear motion. If the tool body has the body linear groove, the linear actuator has an actuator linear groove insert sliding in the body linear groove. If the tool body has the body groove insert, the actuator body has an actuator body groove in which the body groove insert slides.

The linear actuator can be moved by a screw and thread interaction in one embodiment, or by a thumb-activated pusher aided by a spring in another embodiment. Yet a further embodiment may include a worm gear and worm interaction. The screw and thread embodiment advantageously may include a thumb wheel for turning the screw, and the entire embodiment advantageously may be made out of plastic, and 3-D printed.

The plastic may be for example (ABS Acrylonitrile butadiene styrene) or PETG (Polyethylene Terephthlate Glycol-Modified), or TPU (Thermoplastic Polyurethane) and all of the parts can be 3-D printed using the plastic.

The use of an entirely plastic tool mitigates foreign object damage risk in the event of fragments breaking off and getting into the turbine, since the plastic will simply burn off.

The present invention thus also provides an installation tool for an airfoil trim balance weight consisting entirely of plastic.

Rapid response to changes in design also are possible by the 3-D printing.

The present invention thus also provides an installation tool for an airfoil trim balance weight made by 3-D printing.

The present invention also provides a method for installing an airfoil trim balance weight comprising bending a tab using a linear motion. A gas turbine engine comprising an airfoil trim balance weight installed by the method is also provided, the gas turbine engine preferably being an aircraft engine.

The present invention also provides a method for manufacturing an installation tool for an airfoil trim balance weight comprising: 3-D printing at least part of the installation tool.

3D printing can generate atypical geometries to support the trim balance weight installation and accommodate for the throat geometry.

Preferably all parts of the installation tool are 3-D printed.

### BRIEF DESCRIPTION OF THE DRAWINGS

FIGS. 1, 2 and 3 show the general state of the art and are described above, showing a rotor section and blade with a trim balance weight.

Two non-limiting embodiments of the present invention are shown with reference to the following drawings, in which:

FIG. 4 shows the pre-bend tab 204 and post bend tab 204′ of the present invention for folding a tab of a trim balance weight;

FIG. 5 shows a first embodiment of the installation tool of the present invention in a retracted position;

FIGS. 6, 7, 8, 9, 10 and 11 show the individual 3-D printed parts of the embodiment of FIG. 5;

FIG. 12 shows the thumb screw, screw and thread body parts of the FIG. 5 embodiment;

FIG. 13 shows the installation tool of FIG. 5 nested in position prior to tab bending;

FIG. 14 shows schematically the installation tool having deformed the tab, with the low pressure turbine blade of the rotor not being shown for clarity;

FIGS. 15 and 16 show schematic isometric views of a second installation tool embodiment with a thumb-activated pusher.

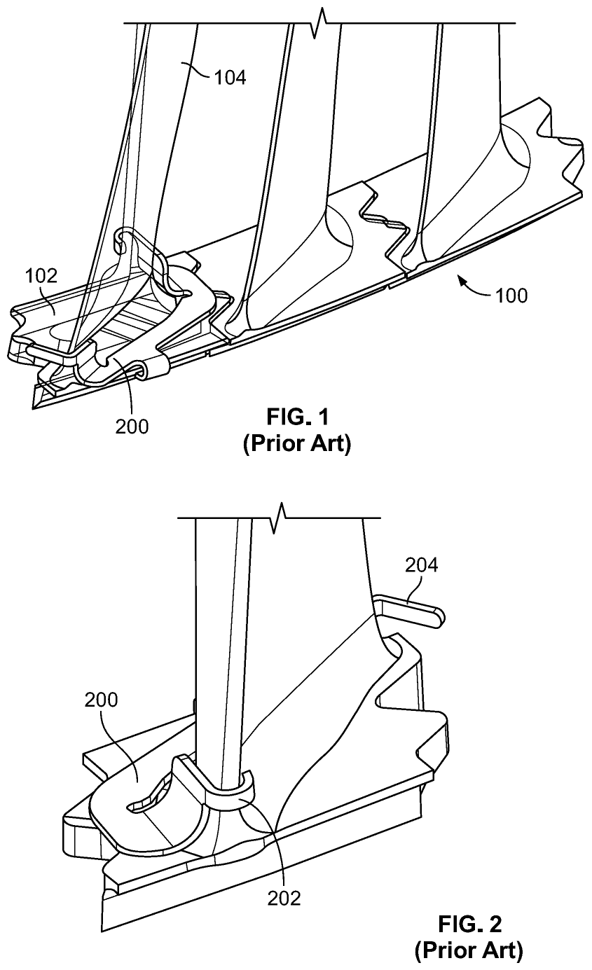

### DETAILED DESCRIPTION OF THE PREFERRED EMBODIMENTS

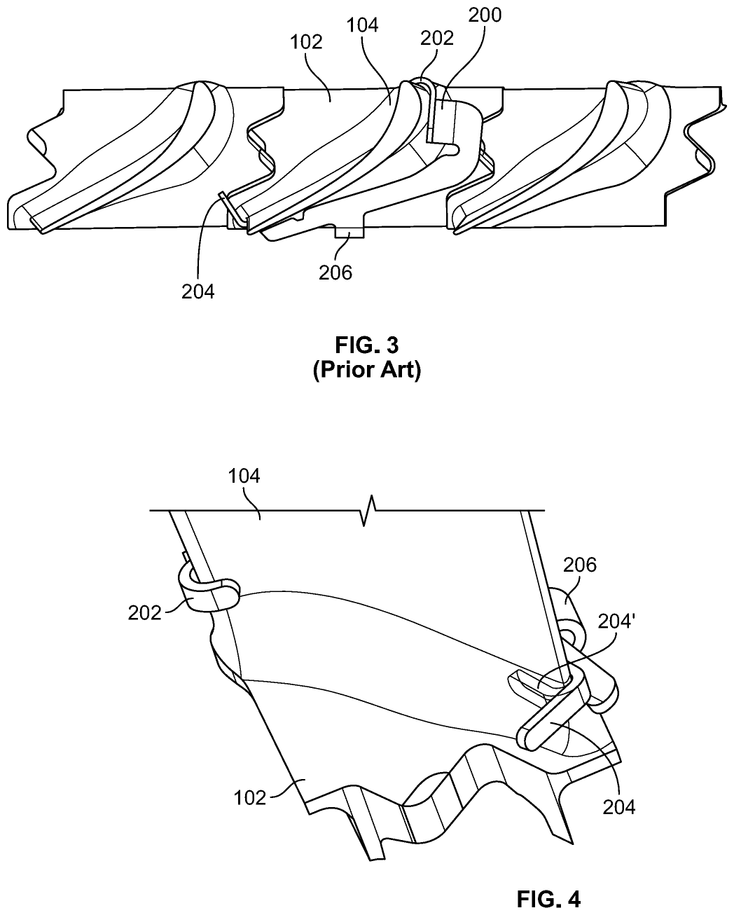

FIG. 4 shows a part of a gas turbine engine, for example a low pressure turbine of an aircraft engine, and having a rotor blade 104 and a platform 102 which can interlock with similar platforms to form a fully circumferential rotor stage. A trim balance weight can be placed near the blade 104/platform 102 interface so that a tab 202 extends over a leading edge of the blade 104, and a tab 206 extends over a platform edge of platform 102. A linear motion of the present invention folds a tab 204 of the trim balance weight around the trailing edge of blade 104 to an installation position 204′. Using the installation tool and method of the present invention, the trim balance weight is secured to blade 104.

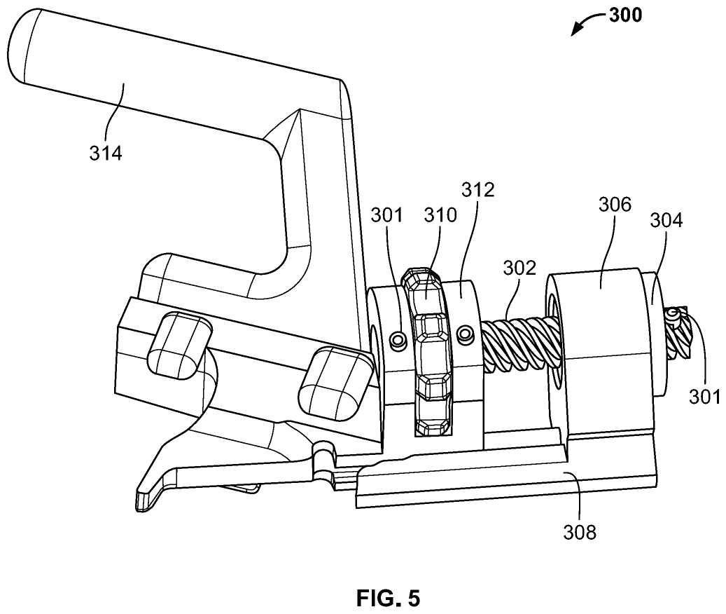

FIG. 5 shows a first embodiment of an installation tool 300 of the present invention in a retracted position. Tool 300 in this preferred non-limiting embodiment is manufactured completely by 3-D printing a plastic such as an ABS or PETG plastic as will be described. Should a part or the entirety of the tool 300 be left in the engine, the plastic will burn up, minimizing foreign object damage.

Tool 300 has a tool body 312, a handle 314 fixedly connected to the tool body 312, for example via a friction fit, and a linear actuator 308. Linear actuator 308 has an integral thread support 306, which fixedly supports an internally-threaded thread nut 304. Thread nut 304 can fit into a hole on the integral thread support. A radially-extending flange on the thread nut 304 can rest against a side surface of the thread support 306.

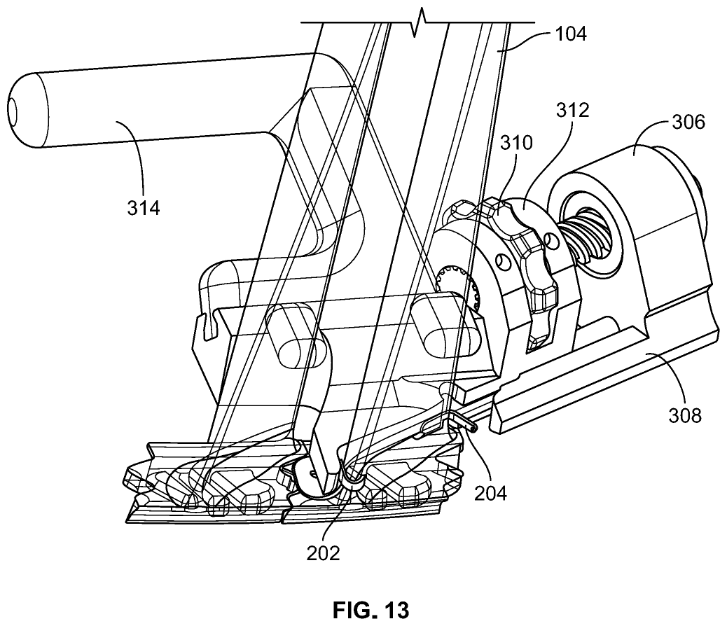

As shown in FIG. 9, tool body 312 can have two parallel spaced-apart thumb-screw supports, as well as a support 313 with a support surface 317 extending perpendicularly with respect to the linear motion, i.e. between 60 and 120 degrees, and forming a general L shape with a tool body surface 315 for interacting with an airfoil surface, for example a suction surface of the airfoil. Most preferably the angle between the support surface 317 and the tool body surface 315 is more than 90 degrees, for example between 90 and 120 degrees, so that placement of the support surface 317 over the leading edge or a tab of the trim balance weight is simplified as will be described with respect to FIG. 13 below. Tool body 312 also can have two bumpers 319 to aid in positioning of the tool on the airfoil or an adjacent airfoil.

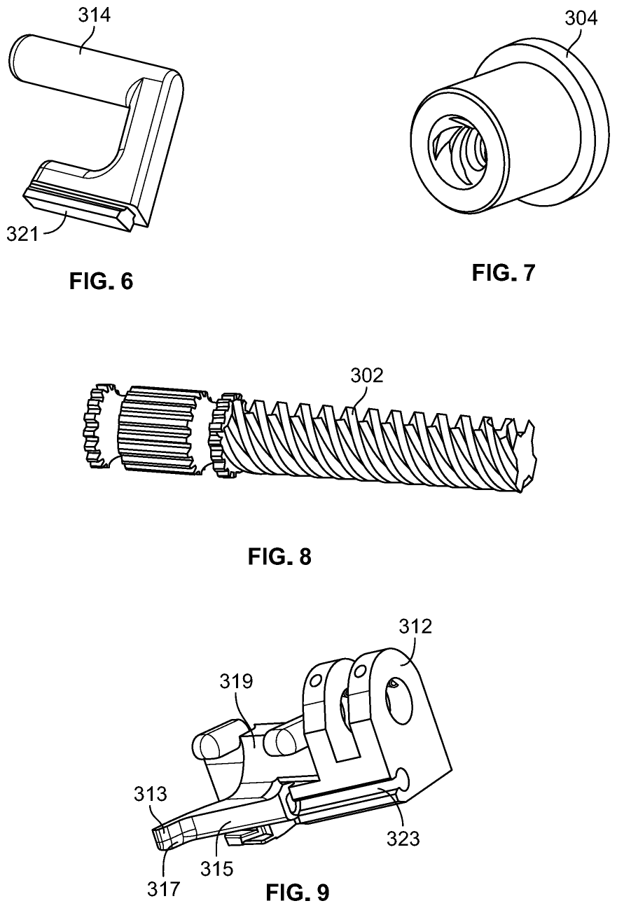

Tool body 312 can be fixed to handle 314, shown in FIG. 6 via an insert 321 interacting via a friction fit with a slot of the body 312 on the side not shown in FIG. 9.

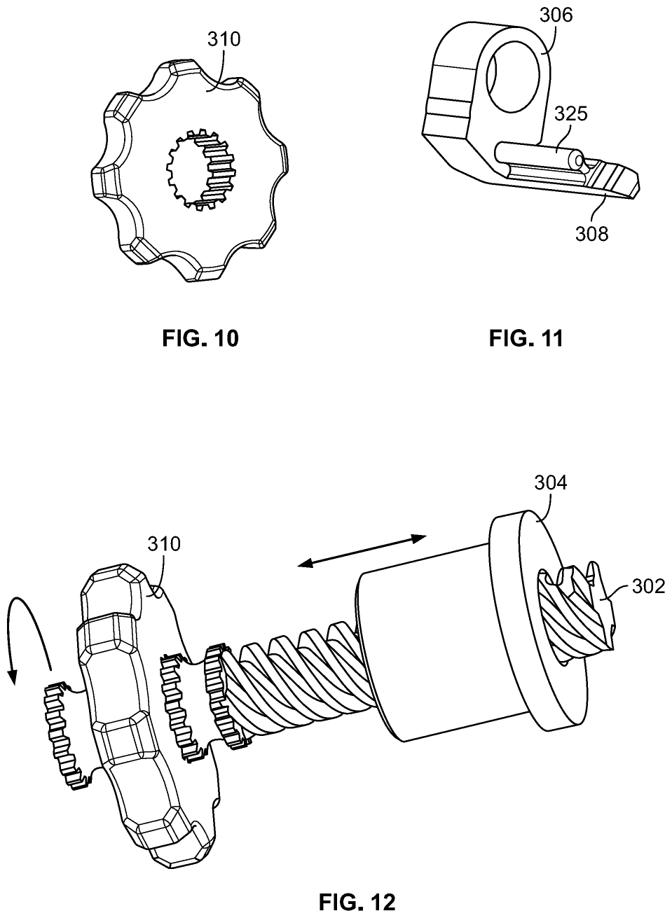

FIG. 10 shows thumb screw 310 which can fit between the two thumb-screw supports of tool body 312 and receive a linearly grooved first end of a screw 302 shown in FIG. 8 via a press fit. Thus 3-D printed handle 314, tool body 312, thumb screw 310 and screw 302 can all be press fit together, with thumb screw 310 being supported for rotational movement and permitting the screw 302 to rotate.

Thread nut 304, shown in FIG. 7, can be press fit into thread support 306 of linear actuator 308 shown in FIG. 11, and a groove insert 325 of linear actuator 308 can then be placed in a groove 323 of tool body 312, in this embodiment the groove insert 325 being a rod matching a rounded groove 323. The interior thread of thread nut 304 then reaches the external thread of screw 302. The external thread for example can be an ACME 4 start thread which advantageously permits high linear movement with each rotation of the thumbwheel, as shown schematically in FIG. 12 without the linear actuator 306 and tool body 312 for illustrative purposes.

The operator can then rotate the thumb screw 310 and thread screw 302 into thread nut 304, so that linear actuator 308 can move linearly toward support 313, aided by the linear groove 323 and groove insert 325 interaction. A 3-D printed pin 301 (FIG. 5) can be press fit into a cross hole in the screw 302 to prevent the linear actuator 308 from coming off when the linear actuator is moved away from the support 313. Pin 301 retains screw 302 to body 312.

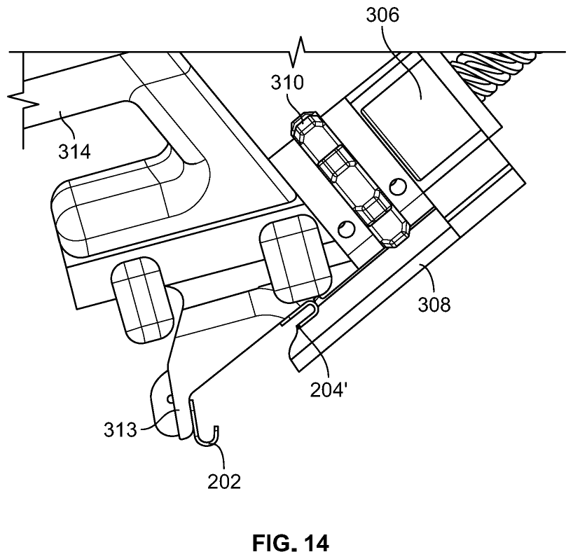

FIG. 13 shows the installation tool of FIG. 5 nested in position, with support 313 engaging the tab 202 at the leading edge of the blade 104, and the bumpers 319 of the tool body can rest against blades 104 for example at the trailing edges of two adjacent blades, and the tool body surface 315 (FIG. 9) can rest against the suction side of blade 104. Installation tool 300 thus can be firmly positioned against the rotor blades during installation and as an operator rotates thumb screw 310 linear actuator 308 moves linearly to bend tab 204 into position 204′ as shown in FIG. 14 without the blade 104 being shown for illustrative purposes.

Errors or improper bends with loose tools can be avoided, and the weight 200 more firmly secured to blade 104. Chipping or other damage to the blade 104 can be minimized and the all plastic construction of the tool can reduce foreign object damage as noted above.

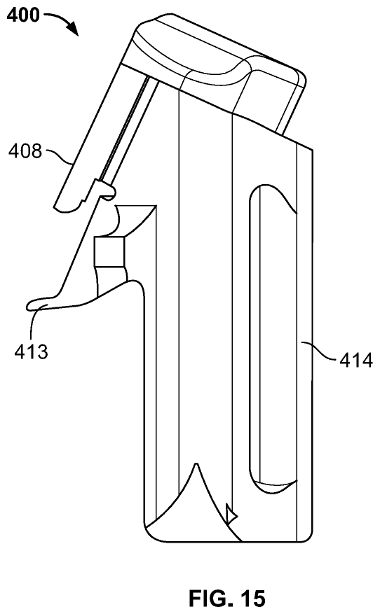

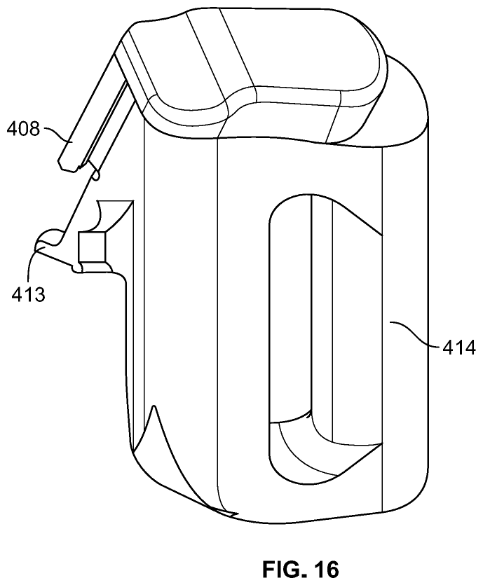

FIGS. 15 and 16 show schematic isometric views of a second installation tool embodiment 400 with a thumb-activated linear actuator 408. A handle 414 of a tool body with a support 413 can be 3-D printed out of plastic in one piece. Linear actuator 408 can be a thumb pusher, retraction aided by 3-D printed elastomeric tension spring between thumb pusher 408 and the tool body. Support 413 thus can interact as support 313 above during installation, and linear actuator 408 can move tab 204 into position 204′ via thumb force and retract via combined thumb and spring force.

A worm and worm screw interaction could also be used, for example with the thumb moving the worm screw to activate a linear motion. The handle 314 can be replaced with a long actuator pole and the thumb screw 310 with a worm gear. Access thus can be extended beyond tailcone reach.

The present invention is limited however not by the embodiments described herein, but by the claims below.

What is claimed is:

1. An installation tool for an airfoil trim balance weight comprising:
a tool body having a support for supporting the tool body with respect to the trim balance weight; and
a linear actuator for contacting a tab of the trim balance weight, the linear actuator for moving linearly with respect to the tool body in a linear motion toward the support to permit the tab to bend.

2. The installation tool as recited in claim 1 wherein the support has a support surface extending perpendicularly with respect to the linear motion.

3. The installation tool as recited in claim 2 wherein the tool body has a tool body surface for interacting with an airfoil surface of the airfoil.

4. The installation tool as recited in claim 3 wherein the support surface and the tool body surface define an angle between 90 and 120 degrees.

5. The installation tool as recited in claim 1 further comprising a handle fixed to the tool body.

6. The installation tool as recited in claim 1 wherein the tool body has a body linear groove or body groove insert extending longitudinally in the direction of the linear motion.

7. The installation tool as recited in claim 7 wherein the linear actuator has an actuator linear groove insert sliding in the body linear groove or an actuator body groove, the body groove insert sliding in the actuator body groove.

8. The installation tool as recited in claim 7 wherein the linear actuator is moved via a screw and thread interaction.

9. The installation tool as recited in claim 1 wherein the tool body and linear actuator are made of plastic.

10. The installation tool as recited in claim 1 wherein an entirety of the installation tool is made of plastic.

11. The installation tool as recited in claim 1 wherein the tool body and linear actuator are made of 3-D printed materials.

12. The installation tool as recited in claim 1 wherein an entirety of the installation tool is made of 3-D printed materials.

13. An installation tool for an airfoil trim balance weight consisting entirely of plastic.

14. An installation tool for an airfoil trim balance weight made by 3-D printing.

15. A method for installing an airfoil trim balance weight comprising bending a tab using a linear motion.

16. A gas turbine engine comprising an airfoil trim balance weight installed by the method as recited in claim 15.

17. An aircraft engine comprising the gas turbine engine as recited in claim 16.

18. A method for manufacturing an installation tool for an airfoil trim balance weight comprising: 3-D printing at least part of the installation tool.

19. The method as recited in claim 18 wherein all parts of the installation tool are 3-D printed.
